(19) United States
(12) Patent Application Publication
(10) Pub. No.: US 2025/0185010 A1
(43) Pub. Date: Jun. 5, 2025

(54) ON-DEMAND SELECTIVE RETRANSMISSIONS FOR UPLINK POSE AND CONTROL INFORMATION IN MOBILE COMMUNICATIONS

(71) Applicant: MediaTek Singapore Pte. Ltd., Singapore (SG)

(72) Inventors: Abdellatif SALAH, Cambridge (GB); Mehmet KUNT, Cambridge (GB); Pradeep JOSE, Cambridge (GB)

(21) Appl. No.: 18/842,995

(22) PCT Filed: Apr. 20, 2023
(86) PCT No.: PCT/CN2023/089505

§ 371 Date: Aug. 30, 2024

Related U.S. Application Data
(60) Provisional application No. 63/335,748, filed on Apr. 28, 2022.

(51) Int. Cl. H04W 72/21; H04W 52/02; H04W 72/115

(52) U.S. Cl. CPC H04W 72/21; H04W 52/0229; H04W 72/115

(57) ABSTRACT

Techniques and solutions pertaining to on-demand selective retransmissions for uplink (UL) pose and/or control information in mobile communications are described. An apparatus (e.g., user equipment (UE)) receives pose or control information. The apparatus performs a selective UL retransmission of the pose or control information.

### CROSS REFERENCE TO RELATED PATENT APPLICATION(S)

The present disclosure is part of a non-provisional application claiming the priority benefit of U.S. Patent Application No. 63/335,748, filed 28 Apr. 2022, the content of which herein being incorporated by reference in its entirety.

### TECHNICAL FIELD

The present disclosure is generally related to mobile communications and, more particularly, to on-demand selective retransmissions for uplink (UL) pose and/or control information in mobile communications.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), there are emerging interests and demands for extended reality (XR) applications (encompassing virtual reality (VR), AR and mixed reality (MR) applications) as “5G killer applications.” In XR traffic, UL control/pose information may include, for example, viewer pose information (describing the state of a viewer of an XR scene as tracked by an XR device or user equipment (UE)), predicted pose, AR pose tracking, user's environment information via sensors, and gaming and/or control events. This information can have different latency and reliability requirements. That is, as different flavors of interactions exist (e.g., viewport adaptation, gaming events, etc.), interaction delay requirements may be different, ranging from immersive latency requirements to more static selection interactions. Therefore, there is a need to perform on-demand and selective retransmissions in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving on-demand selective retransmissions for UL pose and/or control information in mobile communications.

In one aspect, a method may involve a UE receiving pose or control information. The method may also involve the UE performing a selective UL retransmission of the pose or control information.

In another aspect, an apparatus may include a transceiver configured to communicate wirelessly and a processor coupled to the transceiver. The processor may receive pose or control information. The processor may perform a selective UL retransmission of the pose or control information.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIOT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to on-demand selective retransmissions for UL pose and/or control information in mobile communications in mobile communications. According to the present disclosure, a number of possible solutions may be implemented separately or jointly. That is, although these possible solutions may be described below separately, two or more of these possible solutions may be implemented in one combination or another.

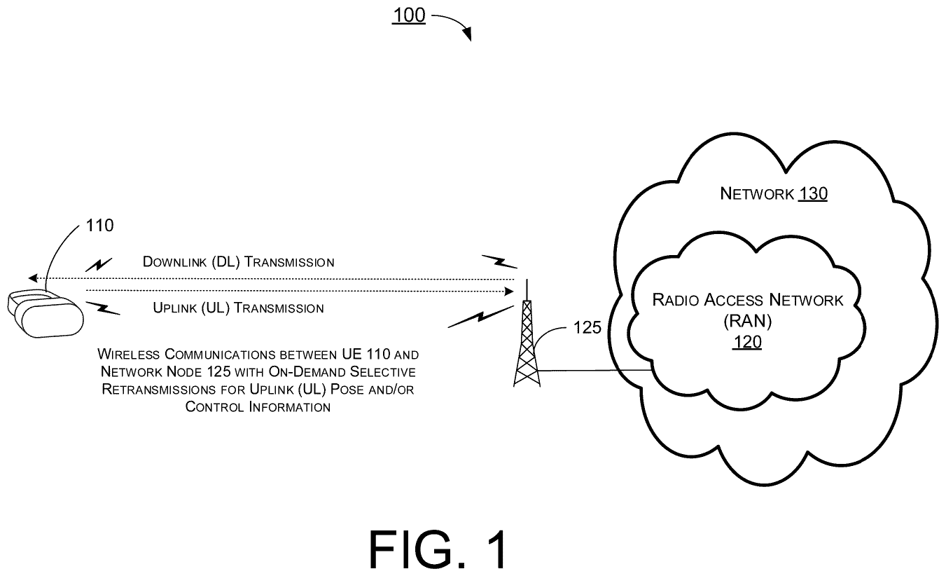

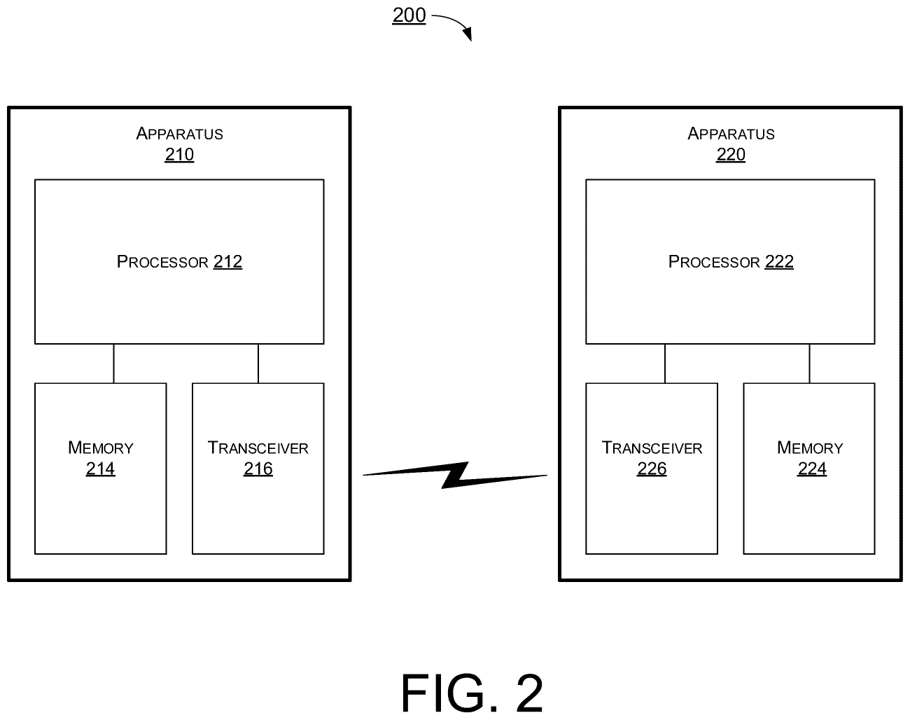

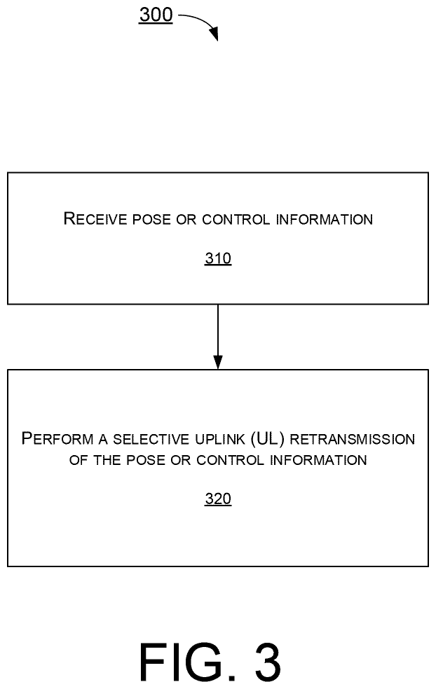

FIG. 1 illustrates an example network environment 100 in which various solutions and schemes in accordance with the present disclosure may be implemented. FIG. 2˜FIG. 3 illustrate examples of implementation of various proposed schemes in network environment 100 in accordance with the present disclosure. The following description of various proposed schemes is provided with reference to FIG. 1˜FIG. 3.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to on-demand selective retransmissions for UL pose and/or control information in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a proposed scheme in accordance with the present disclosure, after transmitting one or more UL pose and/or control information packets, UE 110 may enter a sleep mode and save power, and UE 110 may not need to monitor a physical downlink control channel (PDCCH) for retransmission in case of the UL pose and/or control information packet(s) being of a lower importance or priority (e.g., reporting sensor information) or in case of a latency requirement being relaxed for that specific traffic associated with the pose and/or control information packet(s). It is noteworthy that a packet delay budget (PDB) may be 5 milliseconds (ms) for UL pose and/or control information and the UL pose and/or control information periodicity may be 4 ms (and may be reduced to 2 ms for advanced applications). Hence, under the proposed scheme, for UL packets of a high importance or priority, UE 110 may wait for a next transmission occasion to perform a retransmission and still meet the PDB requirements. Moreover, under the proposed scheme, UE 110 may inform network 130 about whether or not UE 110 is to monitor the PDCCH for possible retransmission or whether UE 110 may enter the sleep mode and stop monitoring the PDCCH.

Under a proposed scheme in accordance with the present disclosure, with a periodic UL traffic for pose and/or control information, UE 110 may piggy-back uplink control information (UCI) to indicate the importance of the pose and/or control information. Alternatively, or additionally, UE 110 may explicitly indicate “UL retransmission enabled” or “UL retransmission disabled” with a flag. In case that the flag is set to indicate “UL retransmission disabled” and in case that a packet fails to be received by network 130, network 130 may not schedule a retransmission. Alternatively, or additionally, network 130 may have a choice to schedule or not schedule a retransmission (e.g., via radio resource control (RRC) configuration). For instance, network 130 may configure UE 110 with “UL retransmission disabled” for some configured grant (CG) occasions and/or resources, some types of UL traffic, and/or some low-priority traffic.

Under a proposed scheme in accordance with the present disclosure, UE 110 may explicitly indicate that “a retransmission can wait for the next occasion” in case that a packet fails to be received by network 130. As a result, network 130 may not schedule a retransmission straight away and may schedule the retransmission in a next UL periodicity. Alternatively, or additionally, network 130 may have a choice to postpone or not postpone a retransmission (e.g., via RRC configuration). For instance, network 130 may configure UE 110 with “delayed retransmissions” for some CG occasions/resources and/or for some types of UL traffic and/or for some low-priority traffic and/or based on PDB. Alternatively, or additionally, UE 110 may indicate that “a retransmission can wait for a specific time duration” in case that a packet fails to be received by network 130. For instance, the time duration may be selected by UE 110 from a set of values configured by network 130 via RRC signaling or, alternatively, UE 110 may indicate such duration in terms of a number of periodicities (e.g., 1, 2, 3, . . . ).

Under a proposed scheme in accordance with the present disclosure, for signaling, existing configured grant uplink control information (CG-UCI) may be re-used with some enhancement by re-using existing field(s) or defining additional field(s). The priority of the UL data or pose/control information may be implicit from (e.g., corresponding to) a logical control channel (LCH) to which the data or pose/control information is mapped (e.g., as with packet filtering). Under the proposed scheme, LCH restrictions for CGs may exist, so that a set of LCHs may be mapped to a CG configuration, with some LCHs having higher reliability requirements than others. Hence, the medium access control (MAC) layer at UE 110 may set the “UL retransmission enabled/disabled” flag based on the LCH data that is included in a transmitted transport block (TB).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to on-demand selective retransmissions for UL pose and/or control information in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to on-demand selective retransmissions for UL pose and/or control information in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to on-demand selective retransmissions for UL pose and/or control information in mobile communications, processor 212 of apparatus 210, implemented in or as a UE (e.g., UE 110) may receive pose or control information (e.g., from an XR application executed on or by apparatus 210 for UL transmission). Moreover, processor 212 may perform, via transceiver 216, a selective UL retransmission of the pose or control information.

In some implementations, in performing the selective UL retransmission, processor 212 may perform certain operations. For instance, processor 212 may transmit a packet of the pose or control information. Additionally, processor 212 may enter a sleep mode to refrain from monitoring a PDCCH for retransmission in an event that either the UL packet is of a lower importance or a latency requirement is relaxed for a traffic associated with the packet.

In some implementations, in performing the selective UL retransmission, processor 212 may perform other operations. For instance, processor 212 may transmit a packet of the pose or control information. Moreover, processor 212 may retransmit the packet at a next transmission occasion.

In some implementations, in performing the selective UL retransmission, processor 212 may inform a network (e.g., network 130 via apparatus 220 as network node 125) whether the UE is to monitor a PDCCH for retransmission or whether the UE is to enter a sleep mode and stop monitoring the PDCCH.

In some implementations, in performing the selective UL retransmission, processor 212 may perform different operations. For instance, processor 212 may transmit a periodic UL traffic of the pose or control information. Furthermore, processor 212 may indicate to a network (e.g., network 130 via apparatus 220 as network node 125) in UCI an importance of the pose or control information.

In some implementations, in performing the selective UL retransmission, processor 212 may perform certain operations. For instance, processor 212 may transmit a periodic UL traffic of the pose or control information. Additionally, processor 212 may indicate to a network (e.g., network 130 via apparatus 220 as network node 125) in UCI whether UL retransmission is enabled or disabled.

In some implementations, in performing the selective UL retransmission, processor 212 may receive a signaling from a network (e.g., network 130 via apparatus 220 as network node 125) that configures the UE with UL retransmissions disabled for at least one of a CG occasion or resource, a type of UL traffic or a low-priority traffic. In some implementations, the signaling may include a RRC signaling.

In some implementations, in performing the selective UL retransmission, processor 212 may indicate to a network (e.g., network 130 via apparatus 220 as network node 125) that a retransmission of a packet of the pose or control information is held off until a next occasion responsive to the packet failing to be received by the network.

In some implementations, in performing the selective UL retransmission, processor 212 may receive a signaling from a network (e.g., network 130 via apparatus 220 as network node 125) that configures the UE with delayed retransmissions for at least one of a CG occasion or resource, a type of UL traffic or a low-priority traffic, or based on a PDB. In some implementations, the signaling may include a RRC signaling.

In some implementations, in performing the selective UL retransmission, processor 212 may indicate to a network (e.g., network 130 via apparatus 220 as network node 125) that a retransmission of a packet of the pose or control information is held off for a specific time duration responsive to the packet failing to be received by the network. In some implementations, the specific time duration may be selected from a set of values configured by the network. In some implementations, the set of values may be configured by the network via a RRC signaling. Alternatively, or additionally, the specific time duration may be indicated as a number of periodicities.

In some implementations, in performing the selective UL retransmission, processor 212 may indicate to a network (e.g., network 130 via apparatus 220 as network node 125) that a retransmission of a packet of the pose or control information is held off until a next occasion or held off for a specific time duration responsive to the packet failing to be received by the network, and wherein the indicating comprises indicating using CG-UCI.

In some implementations, a priority of UL data may correspond to (e.g., may be implicit from) a LCH to which the UL data is mapped.

In some implementations, in performing the selective UL retransmission, processor 212 may set, at a MAC layer, a flag to indicate UL retransmission enabled or disabled based on a LCH data included in a transmitted TB.

### Illustrative Processes

FIG. 3 illustrates an example process 300 in accordance with an implementation of the present disclosure. Process 300 may represent an aspect of implementing various proposed designs, concepts, schemes, systems and methods described above, whether partially or entirely, including those pertaining to those described above. More specifically, process 300 may represent an aspect of the proposed concepts and schemes pertaining to on-demand selective retransmissions for UL pose and/or control information in mobile communications. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125 or another network node implementing one or more network-side functionalities described above) of an application server side network (e.g., network 130). Process 300 may begin at block 310.

At 310, process 300 may involve processor 212 of apparatus 210, implemented in or as a UE (e.g., UE 110) receiving pose or control information (e.g., from an XR application executed on or by apparatus 210 for UL transmission). Process 300 may proceed from 310 to 320.

At 320, process 300 may involve processor 212 performing, via transceiver 216, a selective UL retransmission of the pose or control information.

In some implementations, in performing the selective UL retransmission, process 300 may involve processor 212 performing certain operations. For instance, process 300 may involve processor 212 transmitting a packet of the pose or control information. Additionally, process 300 may involve processor 212 entering a sleep mode to refrain from monitoring a PDCCH for retransmission in an event that either the UL packet is of a lower importance or a latency requirement is relaxed for a traffic associated with the packet.

In some implementations, in performing the selective UL retransmission, process 300 may involve processor 212 performing other operations. For instance, process 300 may involve processor 212 transmitting a packet of the pose or control information. Moreover, process 300 may involve processor 212 retransmitting the packet at a next transmission occasion.

In some implementations, in performing the selective UL retransmission, process 300 may involve processor 212 informing a network (e.g., network 130 via apparatus 220 as network node 125) whether the UE is to monitor a PDCCH for retransmission or whether the UE is to enter a sleep mode and stop monitoring the PDCCH.

In some implementations, in performing the selective UL retransmission, process 300 may involve processor 212 performing different operations. For instance, process 300 may involve processor 212 transmitting a periodic UL traffic of the pose or control information. Furthermore, process 300 may involve processor 212 indicating to a network (e.g., network 130 via apparatus 220 as network node 125) in UCI an importance of the pose or control information.

In some implementations, in performing the selective UL retransmission, process 300 may involve processor 212 performing certain operations. For instance, process 300 may involve processor 212 transmitting a periodic UL traffic of the pose or control information. Additionally, process 300 may involve processor 212 indicating to a network (e.g., network 130 via apparatus 220 as network node 125) in UCI whether UL retransmission is enabled or disabled.

In some implementations, in performing the selective UL retransmission, process 300 may involve processor 212 receiving a signaling from a network (e.g., network 130 via apparatus 220 as network node 125) that configures the UE with UL retransmissions disabled for at least one of a CG occasion or resource, a type of UL traffic or a low-priority traffic. In some implementations, the signaling may include a RRC signaling.

In some implementations, in performing the selective UL retransmission, process 300 may involve processor 212 indicating to a network (e.g., network 130 via apparatus 220 as network node 125) that a retransmission of a packet of the pose or control information is held off until a next occasion responsive to the packet failing to be received by the network.

In some implementations, in performing the selective UL retransmission, process 300 may involve processor 212 receiving a signaling from a network (e.g., network 130 via apparatus 220 as network node 125) that configures the UE with delayed retransmissions for at least one of a CG occasion or resource, a type of UL traffic or a low-priority traffic, or based on a PDB. In some implementations, the signaling may include a RRC signaling.

In some implementations, in performing the selective UL retransmission, process 300 may involve processor 212 indicating to a network (e.g., network 130 via apparatus 220 as network node 125) that a retransmission of a packet of the pose or control information is held off for a specific time duration responsive to the packet failing to be received by the network. In some implementations, the specific time duration may be selected from a set of values configured by the network. In some implementations, the set of values may be configured by the network via a RRC signaling. Alternatively, or additionally, the specific time duration may be indicated as a number of periodicities.

In some implementations, in performing the selective UL retransmission, process 300 may involve processor 212 indicating to a network (e.g., network 130 via apparatus 220 as network node 125) that a retransmission of a packet of the pose or control information is held off until a next occasion or held off for a specific time duration responsive to the packet failing to be received by the network, and wherein the indicating comprises indicating using CG-UCI.

In some implementations, a priority of UL data may correspond to (e.g., may be implicit from) a LCH to which the UL data is mapped.

In some implementations, in performing the selective UL retransmission, process 300 may involve processor 212 setting, at a MAC layer, a flag to indicate UL retransmission enabled or disabled based on a LCH data included in a transmitted TB.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method implementable in a user equipment (UE), comprising:
receiving pose or control information; and
performing a selective uplink (UL) retransmission of the pose or control information.

2. The method of claim 1, wherein the performing of the selective UL retransmission comprises:
transmitting a packet of the pose or control information; and
entering a sleep mode to refrain from monitoring a physical downlink control channel (PDCCH) for retransmission.

3. The method of claim 1, wherein the performing of the selective UL retransmission comprises:
transmitting a packet of the pose or control information; and
retransmitting the packet at a next transmission occasion.

4. The method of claim 1, wherein the performing of the selective UL retransmission comprises informing a network whether the UE is to monitor a physical downlink control channel (PDCCH) for retransmission or whether the UE is to enter a sleep mode and stop monitoring the PDCCH.

5. The method of claim 1, wherein the performing of the selective UL retransmission comprises:
transmitting a periodic UL traffic of the pose or control information; and
indicating to a network in uplink control information (UCI) an importance of the pose or control information.

6. The method of claim 1, wherein the performing of the selective UL retransmission comprises:
transmitting a periodic UL traffic of the pose or control information; and
indicating to a network in uplink control information (UCI) whether UL retransmission is enabled or disabled.

7. The method of claim 1, wherein the performing of the selective UL retransmission comprises receiving a signaling from a network that configures the UE with UL retransmissions disabled for at least one of a configured grant (CG) occasion or resource, a type of UL traffic or a low-priority traffic.

8. The method of claim 7, wherein the signaling comprises a radio resource control (RRC) signaling.

9. The method of claim 1, wherein the performing of the selective UL retransmission comprises indicating to a network that a retransmission of a packet of the pose or control information is held off until a next occasion responsive to the packet failing to be received by the network.

10. The method of claim 1, wherein the performing of the selective UL retransmission comprises receiving a signaling from a network that configures the UE with delayed retransmissions for at least one of a configured grant (CG) occasion or resource, a type of UL traffic or a low-priority traffic, or based on a packet delay budget (PDB).

11. The method of claim 10, wherein the signaling comprises a radio resource control (RRC) signaling.

12. The method of claim 1, wherein the performing of the selective UL retransmission comprises indicating to a network that a retransmission of a packet of the pose or control information is held off for a specific time duration responsive to the packet failing to be received by the network.

13. The method of claim 12, wherein the specific time duration is selected from a set of values configured by the network.

14. The method of claim 13, wherein the set of values is configured by the network via a radio resource control (RRC) signaling.

15. The method of claim 12, wherein the specific time duration is indicated as a number of periodicities.

16. The method of claim 1, wherein the performing of the selective UL retransmission comprises indicating to a network that a retransmission of a packet of the pose or control information is held off until a next occasion or held off for a specific time duration responsive to the packet failing to be received by the network, and wherein the indicating comprises indicating using configured grant uplink control information (CG-UCI).

17. The method of claim 1, wherein a priority of UL data corresponds to a logical control channel (LCH) to which the UL data is mapped.

18. The method of claim 1, wherein the performing of the selective UL retransmission comprises setting, at a medium access control (MAC) layer, a flag to indicate UL retransmission enabled or disabled based on a logical control channel (LCH) data included in a transmitted transport block (TB).

19. The method of claim 1, wherein the pose or control information comprises pose or control information from an extended reality (XR) application.

20. An apparatus implementable in a user equipment (UE), comprising:
a transceiver configured to communicate wirelessly; and
a processor coupled to the transceiver and configured to perform, via the transceiver, operations comprising:
receiving pose or control information; and
performing a selective uplink (UL) retransmission of the pose or control information.
